(19) United States
(12) Patent Application Publication
(10) Pub. No.: US 2008/0185347 A1
(43) Pub. Date: Aug. 7, 2008

(54) pH-adjusting compositions in water-soluble pouches

(76) Inventors: Thomas Peter Tufano, Wilmington, DE (US); Jordan Alexis Muenchow, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/585,538

(22) Filed: Oct. 24, 2006

(51) Int. Cl. C02F 1/66; C02F 1/68; C09K 3/00

(52) U.S. Cl. 210/749; 252/182.12

(57) ABSTRACT

A composition comprising a pre-measured amount of an acid component and an alkaline component in a sealed water-soluble pouch, said composition when contacted with water generating effervescence and neutralizing the pH of the water is disclosed.

### BACKGROUND OF THE INVENTION

Swimming pool, spa, and hot tub water typically has the alkalinity adjusted to from about 80 to about 150 mg/L, the calcium hardness adjusted to from about 200 to about 400 mg/L, and the pH adjusted to 7.2 to 7.8 using standard swimming pool chemicals. However, regular use of an alkaline chlorine sanitizer such as calcium hypochlorite or an acidic chlorine sanitizer such as trichloroisocyanuric acid will, respectively and over time, drive the pH above or below the desirable range. A pH below this range can result in water that is corrosive to metal plumbing, equipment, and fixtures. A pH above this range can result in water that is scale-forming and leads to unsightly and problematic deposits of calcium salts on pool and equipment surfaces. Many of the dry chemicals used for pH adjustment pose hazards for the user in terms of skin irritation, irritating dusts, and the like. Additionally, effective measurement of the amount of a pH-adjusting chemical required may be unavailable or unused by the consumer.

Buckland et al., in U.S. Pat. No. 6,727,219, disclose stabilized potassium hydrogen peroxymonosulfate packaged in a sealed water-soluble pouch. The pouches optionally include various additives, including pH buffers, such as anhydrous sodium carbonate and bicarbonate; active halogen compositions such as halogenated hydantoins; and halogen stabilizers such as cyanuric acid. It is important in U.S. Pat. No. 6,727,219 that the components be anhydrous due to the presence of potassium hydrogen peroxymonosulfate. Buckland et al. does not describe effervescent compositions to aid in pH control.

It is desirable to have prepackaged dosages of chemical compositions that rapidly dissolve in water to either increase or decrease the pH as needed. It is also desirable to have treatment chemicals that are safer to use and that avoid the hazards of skin irritation, dust inhalation, spills, and the like. The present invention provides such prepackaged compositions.

### SUMMARY OF THE INVENTION

The present invention comprises a composition comprising a pre-measured amount of an acid component and an alkaline component in a sealed water-soluble pouch, said composition when contacted with water generating effervescence and neutralizing the pH of the water.

The present invention further comprises a method of adjusting the pH of water comprising contacting with the water a sealed water-soluble pouch containing a pH adjusting composition, said composition comprising a pre-measured amount of an acid component and an alkaline component, and said composition generating effervescence when contacted with the water.

### DETAILED DESCRIPTION

The present invention comprises prepackaged unit-dosage compositions for neutralizing the pH of water. The composition comprises an acidic component and an alkaline component such that the composition is effervescent when contacted with water, and adjusts the water pH. The dry composition is sealed in a pouch made from a water-soluble film which dissolves in contact with water. The pouches are prepared by sealing methods known to those skilled in the art, for example, by using vertical, horizontal, or rotary filling machinery. The dry composition is preferably free-flowing. The unit-dosage composition of the invention is useful for adjusting the pH of recreational, ornamental, and industrial water systems. It is particularly suitable in such systems where water is recirculated, including swimming pools, spas, hot tubs, ornamental fountains, and other recirculating systems. The composition is packaged in pre-measured or unit-dose water-soluble pouches. The compositions are packaged for use to either increase or decrease the pH of water. Optionally and preferably, the pH-increasing and pH-decreasing compositions are coded by one or more of color, pouch shape, labeling or other indication to guide users as to which product to use to neutralize the water pH properly.

The compositions of the present invention are used to conveniently neutralize the pH of the water by adding an appropriate number of unit-dosage packages to the water. The compositions adjust the pH of the water to a range of from about 6.8, to about 8.2, preferably from about 7.2 to about 7.8. The unit-dosage packaging eliminates the need to measure and handle individual chemicals, and thus increases user safety.

The alkaline component of the composition is a dry (but not necessarily anhydrous), powdered or granular, water-soluble, and non-deliquescent alkali metal carbonate, a hydrate thereof, or mixtures thereof. Preferred are alkali metal carbonates, such as sodium carbonate or potassium carbonate. Sodium bicarbonate is effective as the alkaline component in the compositions for increasing pH, but can be incompatible with some pouch materials resulting in tackiness of the film. The acidic component is a dry, but not necessarily anhydrous, powdered or granular, water-soluble, and non-deliquescent acidic material. Such materials include a solid C₂ to C₁₀ mono-, di-, or tri-carboxylic acid; sulfamic acid; acidic salt; solid C₆-C₁₀ aryl sulfonic acid; and an acid having both a sulfonic acid functionality and a carboxylic acid functionality, such as sulfosalicylic acid; a hydrate thereof; or a mixture thereof. The acidic component is a non-deliquescent solid compatible with the pouch material. Preferred are dry di- and tri-carboxylic acids. Especially preferred are itaconic, malic, citric, and succinic acids. An example of an acidic salt suitable for use in this invention is an alkali metal dihydrogen phosphate. Acidic salts that are very weak may be less effective as the ratio of alkaline component to acidic component approaches 1.

The alkaline component, in contact with the acid component and water, provides the effervescence. The effervescence is helpful in distributing the pouch contents within the water being treated. All of the components are compatible with the pouch material. Preferably both the acidic and alkaline components are physically mixed together in a single pouch. Alternatively separate pouches can be used for the acidic and alkaline components, or a single pouch with two compartments, one for the acidic component and one for the alkaline component. However, these alternatives are less preferred because the degree of effervescence would be less when the components are not intimately mixed, and achieving acceptable compatibility between the components and the pouch material becomes more challenging. Sodium bisulfate (sodium hydrogen sulfate) is not preferred due to less compatibility with currently available pouch films. Alkali metal hydroxides are not suitable as the alkaline component since they are deliquescent and incompatible with available water-soluble films. Toxic components, such as oxalic acid, are also not preferred.

The compositions of the present invention have two embodiments. The first embodiment is for increasing pH; the second is for decreasing pH. The compositions of the acidic and alkaline components can be the same in both embodiments, but the ratio of equivalents is optimized to provide effervescence and to produce the desired pH change. The equivalents of a component in a pouch equals the weight of the component divided by its equivalent weight. The packaged product compositions of the present invention are hereinafter described in terms of the ratio of equivalents of the acidic and alkaline components.

The pH-increasing packaged product contains a ratio of equivalents having an excess of the alkaline component. Conversely, the pH-decreasing packaged product contains a ratio of equivalents having an excess of the acidic component. In both compositions, the ratio of equivalents is from about 2:1 to about 20:1, and preferably from about 3:1 to about 10:1. Thus a preferred example of the pH-increasing packaged product contains about 80% by weight sodium carbonate and about 20% by weight malic acid and has a ratio of equivalents of sodium carbonate to malic acid of about 5.1:1. A preferred example of the pH-decreasing packaged product contains about 80% by weight malic acid and about 20% sodium carbonate and has a ratio of equivalents of malic acid to sodium carbonate acid of about 3.2:1.

As the ratio of equivalents of the acidic and alkaline components approaches a ratio of about 1:1, more effervescence is provided, but the compositions have a decreasing ability to adjust pH. Conversely, as the ratio of the acidic and alkaline components diverges, weak effervescence is produced, but the ability to adjust pH increases. It is therefore preferable to have compositions that provide a balance between good effervescence to promote rapid disintegration of the water-soluble film pouch and dissolution of its contents with the ability to adjust pH adequately with a minimum number of doses.

The composition of the present invention is optionally blended with other dry water-treatment chemicals. The types of optional additives are given as examples and are not intended to be all-inclusive. Examples are clarifiers, flocculants, fragrances, corrosion inhibitors, chelating agents, enzymes, and diluents. Other optional additives are colorants to differentiate pH-increasing and pH-decreasing compositions. Any color pair may be used, for instance colors can be chosen to match pH test strips or kits commercially available, for example, for testing of pool and spa water.

The cold-water-soluble films useful in making the pouches used in the present invention are described, for example, in U.S. Pat. No. 6,787,512, herein incorporated by reference. The films are formulated with hydrolyzed copolymers of vinyl acetate and a second monomer having one of either (1) carboxylate functionality or (2) sulfonate functionality. The monomer having carboxylate functionality is selected from monocarboxylic acid vinyl monomers, their esters and anhydrides; and dicarboxylic acid monomers having a polymerizable double bond, their esters and anhydrides, and their alkali metal salts. The monomer having sulfonate functionality is selected from a sulfonic acid monomer such as vinyl sulfonic acid, or its alkali metal salts. The amount of copolymer with carboxylate or sulfonate functionality in the film is from about 40% to about 90% by weight. The copolymer has a degree of hydrolysis, expressed as a percentage of vinyl acetate units converted to vinyl alcohol units of from about 90% to about 100%. The water-soluble film used in the present invention, in addition to the copolymer resin with carboxylate or sulfonate functionality, can contain plasticizers, lubricants, release compositions, fillers, extenders, antiblocking compositions, detackifying compositions, antifoams, and other functional ingredients. Such films are commercially available.

Preferred water-soluble films derived from hydrolyzed vinyl acetate copolymer resins are, for example, MonoSol M8900 and M8630 available from MonoSol LLC in Portage IN. M8630 is an example of a film formulated with a copolymer resin having carboxylate functionality and Monosol M8900 is an example of a film formulated with a copolymer resin having sulfonate functionality. Films derived from sulfonated copolymer resins (for example M8900) are compatible with both pH-increasing (alkaline) and pH-decreasing (acidic) compositions and are preferred. However, films derived from carboxylated copolymer resins (for example M8630) are compatible with alkaline compositions (pH-increasing) but less preferred with acidic compositions (pH-decreasing). In contact with acidic compositions, films derived from carboxylated copolymer resins tend to lose their rapid cold water solubility characteristics.

Film thicknesses useful in the practice of the present invention are from about 1 to about 6 mil (0.025-0.15 mm). Thicker films are preferred for heavier, larger unit-dosages, while thinner films are used for smaller, lighter unit-dosages.

The terms “film disintegration” and “film dissolution” are used herein to describe two stages in the dissolution of a sealed pouch cast into water. “Film disintegration” occurs when the film dissolves sufficiently to admit water. The contents then begin to effervesce, accelerating the further disintegration of the film and the solution and dispersal of the contents. “Film dissolution” occurs subsequently when the fragments of the film have dissolved. The time for a pouch to disintegrate and dissolve is frequently inconsequential. However, when time to disintegrate and dissolve is an issue, compositions with rapid disintegration and dissolution times are preferred.

The present invention further comprises a method of adjusting the pH of water comprising contacting with the water a sealed water-soluble pouch as described above containing a pH adjusting composition as described above, said composition comprising a pre-measured amount of an acid component and an alkaline component, and said composition generating effervescence when contacted with the water. One or more unit-dosage pouches are cast into the water requiring pH adjustment. When cast into water at ambient temperature or into heated water, the plastic pouch ruptures, the product composition effervesces accelerating further disintegration and dissolution of the film and composition. This simultaneously provides visual confirmation of the pH-adjusting process.

The pouches used in the present invention are made in any convenient size to contain sufficient excess acid or alkali to adjust the pH. As an example, one preferred composition is a 4:1 ratio of equivalents of anhydrous sodium carbonate to itaconic acid (to increase pH), or a 4:1 ratio of equivalents of itaconic acid to anhydrous sodium carbonate (to decrease pH). A pouch content of about 15 to about 60 g is suitable for a spa of from about 250 to about 500 gallons (950-1900 L). Pouch contents of from about 250 g to about 1 kg are suitable for swimming pools, for example, in the size range of from about 10,000 to about 40,000 gallons (38-150 m³). Thicker films are preferred for the larger pouches. The use of a plurality of unit-dosage pouches is preferred for larger volumes of water since this aids distribution of the chemicals throughout the volume of water. The pouch and its contents typically have a specific gravity between about 1.0 and about 1.25.

The advantages of the present invention in the treatment of recreational, industrial, and ornamental water systems include, (a) convenience of pre-measured unit dose packaging, (b) rapid dissolution due to effervescent characteristics, (c) avoidance of direct contact for the user with the chemicals and with dust from the chemicals, and (d), ease of use due to indicators (color, shape, and the like) to guide the user as to which product should be used to adjust the pH, thus enhancing safety in use.

### Materials and Test Methods

The following materials and test methods were used in the examples herein.

Anhydrous sodium carbonate was obtained from FMC Corporation, Philadelphia Pa.

Sodium bicarbonate, sodium bisulfate, potassium hydroxide and sulfamic acid were obtained from EMD Chemicals, Inc., Gibbstown N.J.

A buffer blend of boric acid (98%) and sodium carbonate (2%), glycolic acid (99%, crystalline), and OXONE monopersulfate compound were obtained from E. I. du Pont de Nemours and Company, Wilmington Del.

All other organic carboxylic acids, sulfonic acids, and potassium dihydrogen phosphate were obtained from Sigma-Aldrich Company, Milwaukee Wis.

M8630 and M8900 water-soluble films were obtained from MonoSol, LLC, Portage, Ind. All films were 1.5 mil (0.038 mm) in thickness, except as noted for Example 51 (3.0 mil, 0.076 mm) in Table 4.

Pouches—Sample water-soluble pouches were prepared manually using the M8630 and M8900 films and a laboratory heat sealer, Model YH-230S, obtained from HeatSealers.net (Jericho, N.Y.) and used according to the manufacturer's recommendations. Pouch chemicals were individually weighed and premixed before sealing into a pouch.

### Test Method 1—Film Disintegration/Dissolution Tests.

The subject tests were performed as described in MonoSol Test Method 205 (MSTM 205) in U.S. Pat. No. 6,787,512. This test is conducted as follows. Three test specimens were cut from each film to be tested using a stainless steel template (i.e., 3.8 cm×3.2 cm). Each specimen was locked into a separate 35 mm slide mount. A beaker was filled with 500 mL of distilled water, and was heated or cooled as necessary to maintain a temperature of 20° C. The height of the column of water was marked and a magnetic stirring rod added. The water was stirred using a magnetic stirrer to develop a vortex about one-fifth the height of the water column. The depth of the vortex was marked. The slide mount was clamped into an adjustable holder so that its shorter side was parallel to the side of the beaker and its longer side was parallel to the water surface. The slide mount was positioned directly over the center of the stirring rod such that the film surface was positioned perpendicular to the flow of the water. The secured slide was inserted by dropping the slide and clamp into the water and timing begun. Time to disintegration (when the film breaks apart) was measured. When all film was released from the slide mount, the slide mount was raised out of the water. Time to film dissolution (when all film fragments are no longer visible and solution becomes clear) was measured.

### Test Method 2—pH Measurements

All pH measurements were made using an Orion PERPHECT LOGR meter, model #310, used in accordance with the manufacturer's procedures.

### Test Method 3—Degree of Effervescence

The Degree of Effervescence was rated on a scale of 0-5 as follows and was based on contacting about 10 g of the sample with about 3 mL water in a shallow dish:
0—No fizzing sounds or increase in foam height.
1—Faint fizzing sounds, no noticeable increase in foam height.
2—Faint fizzing sounds, foam height reached 0.5 cm.
3—Moderate fizzing sounds, foam height reached 1.0 cm.
4—Moderate fizzing sounds, foam height reached 2.0 cm.
5—Strong fizzing sounds, foam height reached 2.5 cm.
   Higher ratings denote more effervescence and are preferred.

### Test Method 4—Film Integrity and Product Integrity

The film integrity (assessed by the degree of brittleness, tack, rupturability, and discoloration) and the product integrity (assessed by the free-flowing characteristics, discoloration, and adherence to the film) were rated on scales of 1 to 5, as follows: 1—Poor, 2—Fair, 3—Good, 4—Very good, and 5—Excellent. Higher ratings denote better film and product integrity and are preferred.

### EXAMPLES

In the Tables the equivalents ratios are denoted as alkali/acid equivalents. This is the same as alkali:acid equivalents.

### Examples 1-34

For these examples, a dose is defined as 28 grams of the composition per 300 gallons (1136 L) of water (equivalent to 24.65 mg/L). To 4.0 L of deionized water at room temperature (22+/−2° C.), 3.20 g of a blend of boric acid (98%) and sodium carbonate (2%) was added to establish pH buffer chemistry similar to that used in residential spas and hot tubs. Ten grams of each of the pH-increasing and pH-decreasing compositions listed in Tables 1 and 2 were prepared by combining the appropriate quantities of the components in granular form and blending in a small vial. The compositions were not enclosed in a pouch. The pH of the buffered water was then lowered to 6.6 to 6.8 by adding dropwise 20% sulfuric acid. A pH-increasing composition as defined in Table 1 was selected and added in discrete doses (98.6 mg corresponding to 24.65 mg/L) until the pH recovered back to within acceptable limits (7.2-7.8). The initial and final pH values were recorded as well as the number of doses required to achieve the pH change. At this point the pH of the buffered water was raised to 8.2 to 8.4 by initially adding solid potassium hydroxide pellets and making final adjustments dropwise with a 10% potassium hydroxide solution. A pH-decreasing composition as defined in Table 2 was selected and added in discrete doses (98.6 mg corresponding to 24.65 mg/L) until the pH recovered back to within acceptable limits (7.2 to 7.8). During addition, the time for complete dissolution of the granular compositions was recorded. The procedure was then repeated with another pH-increasing and pH-decreasing pair with a fresh 4.0-L sample of buffered water. After the pH dose response test was completed with a selected composition, the remainder of the 10-gram sample of the composition was placed in a shallow dish and treated with approximately 3 mL of de-ionized water. In each case the degree of effervescence was evaluated and recorded using Test Method 3. The resulting dissolution time of a unit dose of each composition, the pH dose response characteristics of the composition, and the degree of effervescence of the composition are given in Tables 1 and 2 below.

### Comparative Examples A-G

Sodium bicarbonate (Comparative Examples A, D and G), sodium carbonate (Comparative Example B) and sodium bisulfate (Comparative Example E respectively) were commercially available products in granular form. Comparative Example C was a mixture of sodium carbonate and adipic acid for increasing pH. Comparative Example F was a mixture of sodium carbonate and adipic acid for decreasing pH. The procedure and testing used for these comparative examples was the same as described above in Examples 1-34. In Comparative Examples A-G, the granular materials were not contained in a pouch. The results for Comparative Examples A-G are also given in Tables 1 and 2.

Chemical abbreviations and notes for Tables 1 and 2 follow Table 2.

TABLE 1
pH-increasing Compositions

| | | Alkali/Acid | | | | | |
|---|---|---|---|---|---|---|---|
| | | Equivalents | Dissolution | Initial | Final | # of | Degree of |
| Ex. # | Composition | Ratio | Time (s) | pH | pH | Doses | Effervescence |
| 2 | Na₂CO₃/Malic | 4/1 | <30 | 6.72 | 7.21 | 1 | 5 |
| | Acid | | | | | | |
| 7 | Na₂CO₃/Tartaric | 5/1 | <30 | 6.8 | 7.27 | 1 | 5 |
| | Acid | | | | | | |
| 4 | Na₂CO₃/Citric | 3/1 | <30 | 6.75 | 7.30 | 2 | 5 |
| | Acid | | | | | | |
| 15 | Na₂CO₃/Sulfamic | 2/1 | <30 | 6.8 | 7.22 | 2 | 5 |
| | Acid | | | | | | |
| 3 | Na₂CO₃/Malic | 2/1 | <30 | 6.7 | 7.21 | 5 | 5 |
| | Acid | | | | | | |
| 6 | Na₂CO₃/Adipic | 2/1 | 120–180 | 6.76 | 7.21 | 6 | 5 |
| | Acid | | | | | | |
| 9 | Na₂CO₃/Itaconic | 2/1 | <30 | 6.78 | 7.2 | 7 | 5 |
| | Acid | | | | | | |
| 16 | Na₂CO₃/5- | 12/1 | <30 | 6.65 | 7.43 | 1 | 3 |
| | SSADH | | | | | | |
| 13 | Na₂CO₃/Glycolic | 8/1 | <30 | 6.8 | 7.47 | 1 | 3 |
| | Acid | | | | | | |
| 11 | Na₂CO₃/Succinic | 15/1 | 30–60 | 6.74 | 7.43 | 1 | 2 |
| | Acid | | | | | | |
| 14 | Na₂CO₃/Sulfamic | 20/1 | <30 | 6.78 | 7.43 | 1 | 2 |
| | Acid | | | | | | |
| 1 | Na₂CO₃/Malic | 20/1 | <30 | 6.76 | 7.46 | 1 | 1 |
| | Acid | | | | | | |
| 5 | Na₂CO₃/Adipic | 20/1 | <30 | 6.73 | 7.38 | 1 | 1 |
| | Acid | | | | | | |
| 8 | Na₂CO₃/Itaconic | 20/1 | <30 | 6.61 | 7.31 | 1 | 1 |
| | Acid | | | | | | |
| 10 | Na₂CO₃/Succinic | 23/1 | 30–60 | 6.79 | 7.49 | 1 | 1 |
| | Acid | | | | | | |
| 12 | Na₂CO₃/Succinic | 10/1 | 60–120 | 6.68 | 7.43 | 1 | 1 |
| | Acid | | | | | | |
| 17 | Na₂CO₃/KH₂PO₄ | 20/1 | <30 | 6.79 | 7.47 | 1 | 1 |
| 18 | Na₂CO₃/KH₂PO₄ | 2/1 | 30–60 | 6.78 | 7.26 | 1 | 1 |
| C | Na₂CO₃/Adipic | 1.5/1 | 120–180 | 6.77 | 6.82 | 7 | 5 |
| | Acid | | | | | | |
| D | NaHCO₃/Succinic | 15/1 | 30–60 | 6.62 | 7.25 | 4 | 3 |
| | Acid | | | | | | |
| B | Na₂CO₃ | 100% | 30–60 | 6.67 | 7.47 | 1 | 0 |
| A | NaHCO₃ | 100% | 30–60 | 6.67 | 7.24 | 4 | 0 |

TABLE 2
pH-decreasing Compositions

| | | Acid/Alkali | | | | | |
|---|---|---|---|---|---|---|---|
| | | Equivalents | Dissolution | Initial | Final | # of | Degree of |
| Ex. # | Composition | Ratio | Time (s) | pH | pH | Doses | Effervescence |
| 20 | Malic Acid/ | 4/1 | <30 | 8.23 | 7.74 | 3 | 5 |
| | Na₂CO₃ | | | | | | |
| 25 | Tartaric Acid/ | 5/1 | <30 | 8.2 | 7.68 | 3 | 5 |
| | Na₂CO₃ | | | | | | |
| 21 | Malic Acid/ | 2/1 | <30 | 8.2 | 7.73 | 4 | 5 |
| | Na₂CO₃ | | | | | | |
| 27 | Itaconic Acid/ | 2/1 | <30 | 8.2 | 7.69 | 4 | 5 |
| | Na₂CO₃ | | | | | | |
| 28 | Succinic Acid/ | 2/1 | 30–60 | 8.22 | 7.61 | 4 | 5 |
| | Na₂CO₃ | | | | | | |
| 29 | Succinic Acid/ | 3/1 | 120–180 | 8.22 | 7.77 | 4 | 5 |
| | Na₂CO₃ | | | | | | |
| 33 | Sulfamic Acid/ | 2/1 | <30 | 8.24 | 7.79 | 5 | 5 |
| | Na₂CO₃ | | | | | | |
| 24 | Adipic Acid/ | 2/1 | 120–180 | 8.2 | 7.73 | 5 | 5 |
| | Na₂CO₃ | | | | | | |
| 22 | Citric Acid/ | 10/1 | <30 | 8.2 | 7.79 | 2 | 4 |
| | Na₂CO₃ | | | | | | |
| 30 | Fumaric Acid/ | 15/1 | 60–120 | 8.2 | 7.80 | 2 | 3 |
| | Na₂CO₃ | | | | | | |
| 31 | Glycolic acid/ | 12/1 | <30 | 8.21 | 7.77 | 3 | 3 |
| | Na₂CO₃ | | | | | | |
| 34 | 5-SSADH*/ | 8/1 | <30 | 8.2 | 7.77 | 4 | 3 |
| | Na₂CO₃ | | | | | | |
| 32 | Sulfamic Acid/ | 20/1 | <30 | 8.24 | 7.62 | 4 | 2 |
| | Na₂CO₃ | | | | | | |
| 19 | Malic Acid/ | 20/1 | <30 | 8.2 | 7.78 | 2 | 1 |
| | Na₂CO₃ | | | | | | |
| 23 | Adipic Acid/ | 20/1 | <30 | 8.26 | 7.78 | 3 | 1 |
| | Na₂CO₃ | | | | | | |
| 26 | Itaconic Acid/ | 20/1 | 30–60 | 8.31 | 7.65 | 3 | 1 |
| | Na₂CO₃ | | | | | | |
| F | Adipic Acid/ | 1.5/1 | 120–180 | 8.20 | 7.70 | 6 | 5 |
| | Na₂CO₃ | | | | | | |
| G | Succinic | 2/1 | 120–180 | 8.27 | 7.62 | 4 | 3 |
| | Acid/NaHCO₃ | | | | | | |
| E | NaHSO₄ | 100% | <30 | 8.26 | 7.50 | 4 | 0 |

*5-SSADH = 5-sulfo-salicylic acid dihydrate.

To show the preferred properties of the granular mixes used in Examples 1-34, Tables 1 and 2 were sorted first by degree of effervescence and then by number of doses. Comparative Examples A-G were sorted similarly but separately.

In both Tables 1 and 2, the data show that preferred compositions of the present invention provided higher degrees of effervescence, shorter dissolution times for the granular product, and required fewer doses to adjust the pH back to within an acceptable range. Note that, in general, higher ratios of equivalents resulted in weaker effervescence but better pH-adjusting characteristics. Lower ratios resulted in stronger effervescence but less pH adjustment.

For Examples 6, 12, 24, 29, and 30, the acidic component had a lower solubility, so the dissolution time was longer (greater than 60 s). Example 12 had low effervescence despite having a lower ratio of equivalents (10:1) because of the lower solubility of the acid component (fumaric acid). Example 15 had good pH adjustment characteristics despite having a low ratio of equivalents (2:1) because of the relatively strong acidity of the acid component (sulfamic acid). Example 18 had low effervescence despite having a low ratio of equivalents (2:1) because potassium dihydrogen phosphate is a weaker acid as compared to malic acid, for example (pH of 1% solution equal to 4.5 versus 2.1, respectively).

Comparative Examples A and B, single component and commercially used pH-increasing compounds, showed no effervescence. Comparative Example E, a single component and commercially used pH-decreasing compound, showed no effervescence. Comparative Example C, with a 1.5/1 alkali/acid equivalents ratio effervesced vigorously, but even with 7 doses failed to adjust the pH to the range of 7.2 to 7.8. Comparative Example F, with a 1.5/1 alkali/acid equivalents ratio effervesced vigorously but also required an excessive number of doses. Comparative Examples C and F illustrated the need for alkali/acid equivalents ratios greater than 1.5:1. Comparative Examples D and G demonstrated effective pH adjustment and good effervescence, but as shown below in Table 3, are less compatible with the pouch material.

### Examples 35-61

Two hundred grams of each of the compositions of the present invention as listed in Tables 3 and 4 were prepared by combining appropriate quantities of the components to obtain the indicated equivalents ratio in a suitable glass jar and blending on a roll mill for 30 minutes. Five 20-gram pouches were prepared manually using the water-soluble film designated in Tables 3 and 4. Pouches were heat-sealed using a laboratory heat sealer, Model YH-230S, obtained from HeatSealers.net (Jericho, N.Y.) and used according to the manufacturer's recommendations. The pouches were placed in secondary, screw-capped high-density polyethylene jars and oven aged at 40° C. and 80% relative humidity (RH) for 4 weeks. After 4 weeks, the pouches were removed from the oven, allowed to cool to room temperature and then evaluated qualitatively for film and product integrity using Test Method 4, as well as film disintegration/dissolution time using Test Method 1.

The results for Examples 35-61 are presented in Tables 3 and 4 below. Higher ratings denote better film and product integrity and are preferred.

### Comparative Examples H-K

Comparative Examples H, J and K were prepared and tested as described for Examples 35 to 61 with the single component sodium bicarbonate or sodium bisulfate. Comparative Example I was prepared and tested as described for Examples 35 to 61. Results are also given in Tables 3 and 4. Film disintegration and dissolution times were determined as described in Test Method 1, and film and product integrity were evaluated using Test Method 4.

TABLE 3
pH-increasing Formulations, Disintegration, Dissolution, and
Film and Product Integrity Results

| | | Alkali/Acid | | Film | Film | | |
|---|---|---|---|---|---|---|---|
| | | Equivalents | Film | Disintegration | Dissolution | Film | Product |
| Ex. #. | Composition | Ratio | Type* | Time (s) | Time (s) | Integrity | Integrity |
| 48 | Na₂CO₃/Fumaric | 4.4/1 | M8900 | 14 | 22 | 5 | 5 |
| | Acid | | | | | | |
| 40 | Na₂CO₃/Adipic | 5.5/1 | M8900 | 12 | 23 | 5 | 5 |
| | Acid | | | | | | |
| 42 | Na₂CO₃/Itaconic | 4.9/1 | M8900 | 12 | 24 | 5 | 5 |
| | Acid | | | | | | |
| 44 | Na₂CO₃/Sebacic | 7.6/1 | M8900 | 15 | 24 | 5 | 5 |
| | Acid | | | | | | |
| 39 | Na₂CO₃/Adipic | 5.5/1 | M8630 | 71 | 237 | 5 | 5 |
| | Acid | | | | | | |
| 36 | Na₂CO₃/Malic | 5.1/1 | M8900 | 11 | 17 | 4 | 5 |
| | Acid | | | | | | |
| 43 | Na₂CO₃/Sebacic | 7.6/1 | M8630 | 12 | 20 | 4 | 5 |
| | Acid | | | | | | |
| 46 | Na₂CO₃/Succinic | 4.5/1 | M8900 | 13 | 21 | 4 | 5 |
| | Acid | | | | | | |
| 47 | Na₂CO₃/Fumaric | 4.4/1 | M8630 | 12 | 25 | 4 | 5 |
| | Acid | | | | | | |
| 35 | Na₂CO₃/Malic | 5.1/1 | M8630 | 15 | 86 | 4 | 5 |
| | Acid | | | | | | |
| 41 | Na₂CO₃/Itaconic | 4.9/1 | M8630 | 120 | >300 | 4 | 5 |
| | Acid | | | | | | |
| 45 | Na₂CO₃/Succinic | 4.5/1 | M8630 | 68 | 107 | 3 | 5 |
| | Acid | | | | | | |
| 37 | Na₂CO₃/Citric | 4.8/1 | M8630 | >300 | >300 | 3 | 5 |
| | Acid | | | | | | |
| 38 | Na₂CO₃/Citric | 22.9/1 | M8630 | >300 | >300 | 3 | 5 |
| | Acid | | | | | | |
| I | NaHCO₃/Citric | 14.5/1 | M8630 | 15 | 22 | 2 | 5 |
| | Acid | | | | | | |
| H | NaHCO₃ | 100% | M8630 | 11 | 16 | 1 | 3 |

TABLE 4
pH-decreasing Formulations, Disintegration, Dissolution, and
Film and Product Integrity Results

| | | Acid/Alkali | | Film | Film | | |
|---|---|---|---|---|---|---|---|
| | | Equivalents | Film | Disintegration | Dissolution | Film | Product |
| Ex. # | Composition | Ratio | Type* | Time (s) | Time (s) | Integrity | Integrity |
| 53 | Adipic | 2.9/1 | M8900 | 12 | 19 | 5 | 5 |
| | Acid/Na₂CO₃ | | | | | | |
| 61 | Fumaric | 3.7/1 | M8900 | 11 | 20 | 5 | 5 |
| | Acid/Na₂CO₃ | | | | | | |
| 57 | Sebacic | 2.1/1 | M8900 | 14 | 21 | 5 | 5 |
| | Acid/Na₂CO₃ | | | | | | |
| 52 | Adipic | 2.9/1 | M8630 | >300 | >300 | 5 | 5 |
| | Acid/Na₂CO₃ | | | | | | |
| 60 | Fumaric | 3.7/1 | M8630 | >300 | >300 | 5 | 5 |
| | Acid/Na₂CO₃ | | | | | | |
| 59 | Succinic | 3.6/1 | M8900 | 12 | 18 | 4 | 5 |
| | Acid/Na₂CO₃ | | | | | | |
| 50 | Malic | 3.2/1 | M8900 | 12 | 20 | 4 | 5 |
| | Acid/Na₂CO₃ | | | | | | |
| 49 | Malic | 3.2/1 | M8630 | 58 | 67 | 4 | 5 |
| | Acid/Na₂CO₃ | | | | | | |
| 56 | Sebacic | 2.1/1 | M8630 | 126 | 150 | 4 | 5 |
| | Acid/Na₂CO₃ | | | | | | |
| 55 | Itaconic | 3.3/1 | M8900 | 52 | 60 | 3 | 4 |
| | Acid/Na₂CO₃ | | | | | | |
| 51 | Citric | 3.3/1 | M8900 | 56 | 98 | 3 | 5 |
| | Acid/Na₂CO₃ | | (3.0 mil) | | | | |
| 54 | Itaconic Acid/ | 3.3/1 | M8630 | >300 | >300 | 3 | 4 |
| | Na₂CO₃ | | | | | | |
| 58 | Succinic Acid/ | 3.6/1 | M8630 | >300 | >300 | 3 | 5 |
| | Na₂CO₃ | | | | | | |
| J | NaHSO₄ | 100% | M8630 | N/A | N/A | 1 | 2 |
| K | NaHSO₄ | 100% | M8900 | N/A | N/A | 1 | 2 |

*Film thickness was 1.5 mil, except as indicated. 1 mil = 0.001 inch = 0.025 mm).

To show the preferred properties of the pouches produced in Examples 35 to 61, Tables 3 and 4 were sorted first by film integrity and then by film dissolution time. Comparative Examples J to K were sorted similarly but separately.

The data in Tables 3 and 4 shows that preferred compositions of the present invention had good compatibility with the water-soluble film as shown by qualitative film and product characteristics and quantitative cold water film disintegration and solubility data.

In Table 3, Examples 37, 38, 39, 41, and 45 are less preferred Examples of the present invention because film disintegration and dissolution times were longer, despite displaying good to excellent film compatibility on the basis of the qualitative assessment.

In Table 4, Examples 52, 54, 56, 58, and 60 had longer film disintegration and dissolution times because the M8630 film derived from a carboxylate copolymer resin is less preferred with acidic pH-decreasing compositions.

In Comparative Example H 100% sodium bicarbonate was incompatible with the film because it made the film tacky and easily ruptured when handled. Comparative Example I is less preferred because the composition made the film slightly tacky and thus easier to rupture when handled. In Comparative Examples J and K, sodium bisulfate had poor compatibility with both types of water-soluble film because of its strong acidity and high solubility in the film matrix. Pouches containing sodium bisulfate rapidly disintegrate and rupture in accelerated aging tests. Water-soluble films used in the present invention are not suitable for packaging sodium bisulfate.

### Examples 62-67

A 300-gallon (1136-L) spa was filled with tap water, heated to 38° C., and conditioned at start-up by addition of the following:

800 mg/L spa buffer, containing boric acid (98%) and sodium carbonate (2%), pH 7.4-7.6,

300 mg/L calcium chloride dihydrate,

50 mg/L sodium bromide

26.4 mg/L OXONE monopersulfate compound

Thirty-gram water-soluble pouches were prepared as described in Examples 35 to 61. The compositions and film types are listed in Table 5. The pH-increasing compositions (Examples 62 to 65) were colored with a red colorant (FD&C Red No. 40) and the pH-decreasing compositions (Examples 566 to 67) were colored with a yellow colorant (FD&C Yellow No. 6). The colorants were selected to match colors on standard test strips for measuring spa water pH. For pH-increasing compositions, the pH of the spa water was first lowered to 6.5 to 6.7 with sodium bisulfate. The pH recovery per dose was observed and recorded. Without discharging and refilling the spa water, the same procedure was followed with pH-decreasing compositions, with the exception that the initial spa water pH was adjusted to 7.9 to 8.0 with solid potassium hydroxide. The dissolution characteristics of the pouches (film and chemical contents) were also observed and recorded. The pouches dissolved completely without residue. All pouch dissolution times were measured with only the recirculation jets on. When aeration jets were also used, pouch dissolution times were further reduced. The resulting data is in Table 5.

TABLE 5
Spa Tests

| | | | | | | | |
|---|---|---|---|---|---|---|---|
| | | | | | | | Dissolution |
| | | Equivalents | Film | | | # of | Time of Pouch |
| Ex. # | Composition | Ratio | Type* | Initial pH | Final pH | Doses | Content(s) |

pH-Increasing Formulations

| | | | | | | | |
|---|---|---|---|---|---|---|---|
| 62 | Na₂CO₃/ | 24.0/1 | M8630 | 6.64 | 7.51 | 2 | 120–180 |
| | Malic Acid | | | | | | |
| 63 | Na₂CO₃/ | 11.4/1 | M8900 | 6.5 | 7.38 | 2 | 60–120 |
| | Malic Acid | | | | | | |
| 64 | Na₂CO₃/ | 5.1/1 | M8630 | 6.6 | 7.39 | 3 | 30–60 |
| | Malic Acid | | | | | | |
| 65 | Na₂CO₃/ | 5.1/1 | M8900 | 6.69 | 7.27 | 3 | <30 |
| | Malic Acid | | | | | | |

pH-Decreasing Formulations

| | | | | | | | |
|---|---|---|---|---|---|---|---|
| 66 | Malic Acid/ | 3.2/1 | M8900 | 7.95 | 7.48 | 3 | 30–60 |
| | Na₂CO₃ | | | | | | |
| 67 | Malic Acid/ | 3.2/1 | M8900 | 7.99 | 7.47 | 3 | 30–60 |
| | Na₂CO₃ | | | | | | |

*Film thickness was 1.5 mil. 1 mil = 0.001 inch = 0.025 mm).

Table 5 shows that water-soluble pouches of the present invention were useful in adjusting the pH of spa water in a full-scale demonstration. Pouches and their contents dissolved rapidly and were effective in adjusting the pH to the desired range.

What is claimed is:

1. A composition comprising a pre-measured amount of an acid component and an alkaline component in a sealed water-soluble pouch, said composition when contacted with water generating effervescence and neutralizing the pH of the water.

2. The composition of claim 1 wherein the neutralizing is to a pH of from about 6.8 to about 8.2.

3. The composition of claim 1 wherein the acid component and alkaline component are each a granular or powdered solid.

4. The composition of claim 1 wherein the acid component is selected from the group consisting of a C₂ to C₁₀ mono-, di-, or tri-carboxylic acid; solid C₆ to C₁₀ aryl sulfonic acid; sulfamic acid; acid having a sulfonic acid functionality and a carboxylic acid functionality; acidic salt; hydrates thereof; or mixtures thereof.

5. The composition of claim 4 wherein the acid component is malic acid, citric acid, itaconic acid, succinic acid or 5-sulfosalicylic acid dihydrate.

6. The composition of claim 1 wherein the alkaline component is an alkali metal carbonate, hydrate thereof, or mixture thereof.

7. The composition of claim 6 wherein the alkaline composition is sodium carbonate.

8. The composition of claim 1 wherein the molar ratio of the acid component to the alkaline component is from about 2:1 to about 20:1.

9. The composition of claim 1 wherein the molar ratio of the alkaline component to the acid component is from about 2:1 to about 20:1.

10. The composition of claim 1 wherein the composition increases pH when added to water and contains a molar excess of the alkaline component.

11. The composition of claim 1 wherein the composition decreases pH when added to water and contains a molar excess of the acid component.

12. The composition of claim 1 further comprising a clarifier, flocculant, fragrance, corrosion inhibitor, chelating agent, enzyme, diluent, or colorant.

13. The composition of claim 1 wherein the pouch comprises a hydrolyzed copolymer of vinyl acetate and a monomer having carboxylate functionality or sulfonate functionality.

14. The composition of claim 1 wherein the pouch has a thickness of from about 1 to about 6 mil.

15. A method of adjusting the pH of water comprising contacting with the water a sealed water-soluble pouch containing composition, said composition comprising a pre-measured amount of an acid component and an alkaline component, and said composition generating effervescence when contacted with the water.

16. The method of claim 15 wherein the acid component is selected from the group consisting of a C₂ to C₁₀ mono-, di-, or tri-carboxylic acid; solid C₆ to C₁₀ aryl sulfonic acid; sulfamic acid; acid having a sulfonic acid functionality and a carboxylic acid functionality; acidic salts; hydrate thereof; or mixture thereof.

17. The method of claim 15 wherein the alkaline component is an alkali metal carbonate, hydrate thereof, or mixture thereof.

18. The method of claim 15 wherein the composition further comprises a clarifier, flocculant, fragrance, corrosion inhibitor, chelating agent, enzyme, diluent, or colorant.

19. The method of claim 15 wherein the pouch and composition together have a specific gravity between 1.0 and 1.25.

20. The method of claim 15 wherein the pouch comprises a hydrolyzed copolymer of vinyl acetate and a monomer having carboxylate functionality or sulfonate functionality.
